(19) United States
(12) Patent Application Publication
(10) Pub. No.: US 2010/0174699 A1
(43) Pub. Date: Jul. 8, 2010

(54) Resident Event Notification System and Display Device

(76) Inventors: Lori-Ann DeRoche, Barrington, IL (US); Richard M. DeRoche, Barrington, IL (US)

Correspondence Address: Lori-Ann DeRoche, 415 June Terrace, Barrington, IL, 60010, US

(21) Appl. No.: 12/205,870

(22) Filed: Jan. 2, 2009

(51) Int. Cl. G06F 17/30; G06F 7/00

(52) U.S. Cl. 707/707; 707/E17.001

(57) ABSTRACT

The Resident Event Notification System and Display Device is a combination of Computer Hardware and Software which will allow consumers the ability to automatically load photographs, music or video over the internet to display device. The display device is a display device between 8″ to 15″ with touch screen capability. The device has an application running which will synchronize with a web portal, downloading any updated content, and uploading synchronizing time and any event acknowledgements. Events, which are scheduled notifications, are displayed on the device at a scheduled time. Residents may acknowledge the event via touching the screen. This acknowledgement is recorded and updated on the web portal. If the event is not acknowledged, it is cleared within 15 minutes.

### COPYRIGHT STATEMENT

Copyright (C) Richard DeRoche and Lori-Ann DeRoche (2008). All Rights Reserved. All materials contained in this document are protected by copyright laws, and may not be reproduced, republished, distributed, transmitted, displayed, broadcast or otherwise exploited in any manner without the express prior written permission of Richard DeRoche or Lori-Ann DeRoche.

### INTELLECTUAL PROPERTY STATEMENT

Unless otherwise noted, all materials, including text, illustrations, photographs, designs, graphics, logos, button icons, images, audio clips, software, written and other material (collectively, the “Contents”) are copyrights, and/or intellectual properties, owned and/or controlled by Richard DeRoche and Lori-Ann DeRoche. U.S. and international copyright laws protect the Contents as a whole.

### PATENT PENDING

U.S. patent application Ser. No. 12/205,870

### VERSION CONTROL

| Date | Comment | Author | Version |
|---|---|---|---|
| Aug. 13, 2008 | Initial Document | Richard M DeRoche | 1.0 |
| | Creation | | |
| Sep. 06, 2008 | Disclaimers and process | Richard M DeRoche | 1.1 |
| | flow additions | | |
| Dec. 28, 2008 | USPTO Removal of | Richard M DeRoche | 1.2 |
| | Diagrams and Process | | |
| Feb. 02, 2009 | Update address and | Richard M DeRoche | 1.3 |
| | Claim | | |

TABLE OF CONTENTS

| Contents | |
|---|---|
| Technical Reference | 4 |
| Background | 4 |
| Concept | 7 |
| Device | 9 |
| Digital display device design | 9 |
| Device Front | 10 |
| Device Rear | 10 |
| Device Side | 10 |
| operating system and application | 11 |
| ServiceS | 13 |
| Web Portal | 14 |

### TECHNICAL REFERENCE

The Resident Event Notification System and Display Device is a combination of Computer Hardware and Software which will allow consumers the ability to automatically load photographs, music or video over the internet to display device. The display device is a display device between 8″ to 15″ with touch screen capability. The device has an application running which will synchronize with a web portal, downloading any updated content, and uploading synchronizing time and any event acknowledgements. Events, which are scheduled notifications, are displayed on the device at a scheduled time. Residents may acknowledge the event via touching the screen. This acknowledgement is recorded and updated on the web portal. If the event is not acknowledged, it is cleared within 15 minutes.

### BACKGROUND

The price of basic digital electronics continues to fall such that one can have an 8″ to 15″ digital photo frame on a desk, store counter or on the living room mantle. It's a personal kiosk or the perfect gift for parents or friends who would like to have pictures plus music of special video or family on display. They are also perfect for a store where the units can be made to loop with the specific slideshow (including text) that you want to display to customers. Almost all digital photo frames allow users to add a memory card for changing the images to be displayed. All have computer chips on board with varying degrees of smarts for adding to or changing how the images are displayed. A few even have touch screen menus.

Three things are lacking in these type devices. First, the machines have a CPU that is being greatly underutilized. Only a very few digital picture frames allow customizing the slideshows adding or deleting images, changing their order and transition effects, etc. For example, only a few digital photo frames support image management software. Also customization of the slideshows and musical accompaniment on the photo frame is fairly primitive. Lack of support for Adobe's Flash Player also looks like a major omission because Flash brings all the media together plus animations and games. Flash programs that make it fun and simple to make slideshows and special transitions and effects. But perhaps of practical value Flash has highly effective compression routines and husbanding of multimedia's memory intensive resources.

The last missing link is that these units can become very attractive selling kiosks in retail settings if WiFi or network linked back to a store central server. Individual retail sales persons could use a remote or touch screen access to bring up a demo presentation and then download the customized details on a customer's flash card or emailed direct. I fully expect this capability to appear in consumer durable pitches say at the Apple Store or your friendly Toyota dealer. Consumers see the pitch on the picture frame/kiosk and then can take it back to their PC or home picture frame customized to sell the details to the partner and/or family.

But the real value of digital photo frames will be primarily as a digital keepsake—replacing one-off picture frames just as surely as digital cameras have replaced film cameras. Offices, hospitals, schools and homes will have these displays in multiple rooms over the next 2-5 years time. Within ten years flat panel television screens will replace prints as wall art in patient rooms.

Sales of flat panel displays have been remarkable. Since they are used in all computer displays and most television screens there has been a tremendous drive to reduce price and increase quality. The displays are starting to get into a price range where they could be considered for wall art in patient rooms.
Having the image illuminated from behind is very pleasing and eliminates the need to consider proper lighting.
Image quality is poor compared to prints but it will satisfy most patients. High-def monitors that look better are available, but they cost more.
Having sideshows with hundreds of images is easy to set up and may be more appealing to some viewers than a static image.
Patients could easily add their own pictures to personalize their room. People love having pictures of their grand children or their pets on screen.
The screen is only 6×8-inches, much too small for wall art in a patient room. Bigger monitors cost much more.
The build quality not good enough to survive in a busy hospital setting.

Setting up a Digital Photo Frame was not easy, and requires working with technical gear. Lots of little annoying things those are specific to this display and not this general idea.
It does not work with Macintosh Computers, only PCs.
It does not work with “progressive” JPGs, only standard JPGs
The optimal image size for the JPGs is 1024×768 pixels, but was printed nowhere in the brief manual or on the box.

The approach to the Resident Event Notification System and Display Device is to simplify the process of setting up a picture frame, adding images and utilizing the device to its fullest. The Resident Event Notification System and Display Device address the problems which are plaguing the industry by;
Eliminating the need to support multiple operating systems.
Scaling display resolutions to provide highest level of picture quality.
Reduce setup time of the frame by linking frame to web site to pull configuration.
Allow for multiple devices to be placed within a single residence.
Customization of the display is performed by the residences family via a web portal.

### CONCEPT

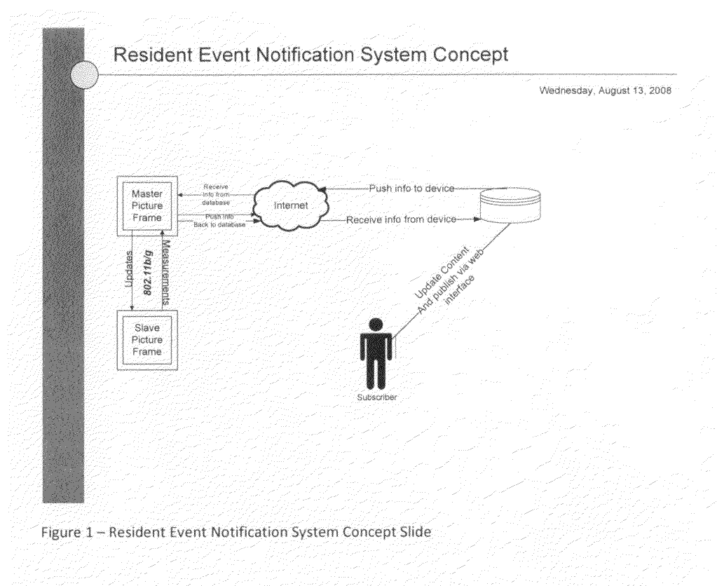

Resident Event Notification System is a digital display device within a home that provides event reminders to individuals with physical impairments such as Alzheimer's, Dementia, or Developmentally Disabled or as a reminder device for any individual. See FIG. 1. The Display Device is an off-the-shelf available device similar to a picture frame but with processing power. The device will offer the ability of receiving data and displaying this data on the screen. Speakers will allow for audio prompts based upon the events scheduled. The hardware device tied to a web portal where the consumer will register the Display Device, add and manage photographs, events, reminders and video which will be pushed to the Display Device.

The web site associated with the device, allows the consumer to load pictures, pre-recorded videos, define events or appointments and receive feedback from the digital device. Once purchased, the consumer will register the device at the website. Once the device has been registered, the consumer will upload pictures, pre-recorded videos and define events. This information will be sent to the device in the users' home via the internet on pre-defined intervals.

Phase I of this design does not receive acknowledgement from the device, however, that will be added in the future. When an event has been scheduled, the event will be displayed on the device until acknowledged by the user, or for a period of 10 minutes. The reminder and content of the device would be managed by a family member or other individual. Using a registration card, anyone the user shares the e-mail address with would be allowed to add events to the frame.

A note of caution on the use of any automated event notification device such as this for the memory impaired. This device improperly used may create potential issues for the intended audience. Customers who have mild cases of dementia or increasing limitations of Alzheimer's may benefit from a device which provides visual and audio reminders. However, these events may also cause disruptive responses. For example, customers with Alzheimer's may perceive the device as an unknown element and be fearful of it. Or they may perceive the audio queue from the device as the voice of “someone unknown” as documented clinically. To alleviate: some of these concerns, events which are recorded for memory impaired individuals would be recorded by a known, recognized family member. As well, events displayed on the screen would be of photographs known to the customer.

### Device

The device itself must support High Speed Internet or Cellular access which will allow for content to be “downloaded” to the frame automatically from a secured website. Managers—defined for purposes of this document are owners or purchasers of the device—would log into a secured web site and manage their devices via this portal. Management of the device would include events or special dates, photographs, videos and audio prompts. The device would have a touch screen allowing the user to interface with the application selecting items such as daily schedule or weather. When prompted, such as a scheduled event, the user may touch the screen to acknowledge an event.

### Digital Display Device Design

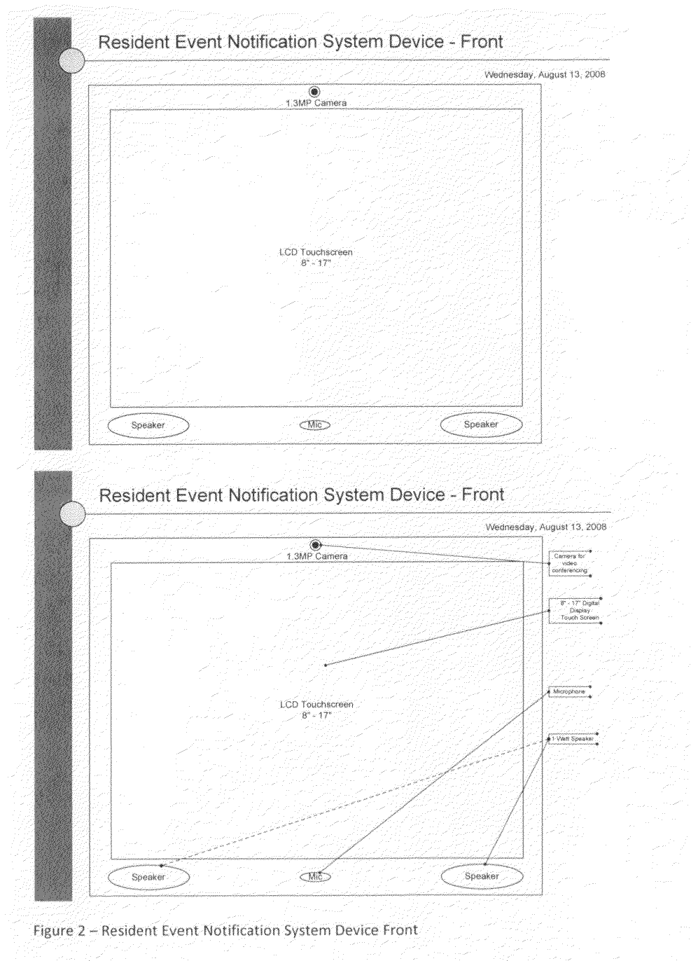

The product would consist of a digital display device between 8″ to 17″ diagonally, with computing capabilities which would present information to a senior on a timed/event basis. See FIGS. 2, 3 and 4. The frame must be capable of being placed onto a horizontal or vertical surface such as a table, countertop, nightstand or wall. Device will consist of the following characteristics;

1. 8″-17″ Digital Display

2. Touch Screen

3. 1.3 Mp or greater video camera

4. Linux Operating System

5. 4 Gb Solid State Storage

6. 512 Mb RAM

7. MP3 Capable

8. Speakers

9. Internal Processor

10. Wired/Wireless Ethernet

11. Cellular Modem

12. Power Adapter and Lithium Ion (Li-Ion) Battery

13. Session Initiated Protocol (SIP)

### Device Front

The front of the device FIG. 2 would have a camera, dual speakers and be between 8″ to 17″ diagonal display with touch screen capabilities. The color of the bezel could be any molded plastic color. Speakers would be 1 watt in power. The touch screen would provide users input capabilities to the device. From an application standpoint, the device is not intended to have a keyboard or mouse attached to the screen. Centered in the top of the digital display device would be a 1.3 mp video camera. This would be used for participation in video conferences.

### Device Rear

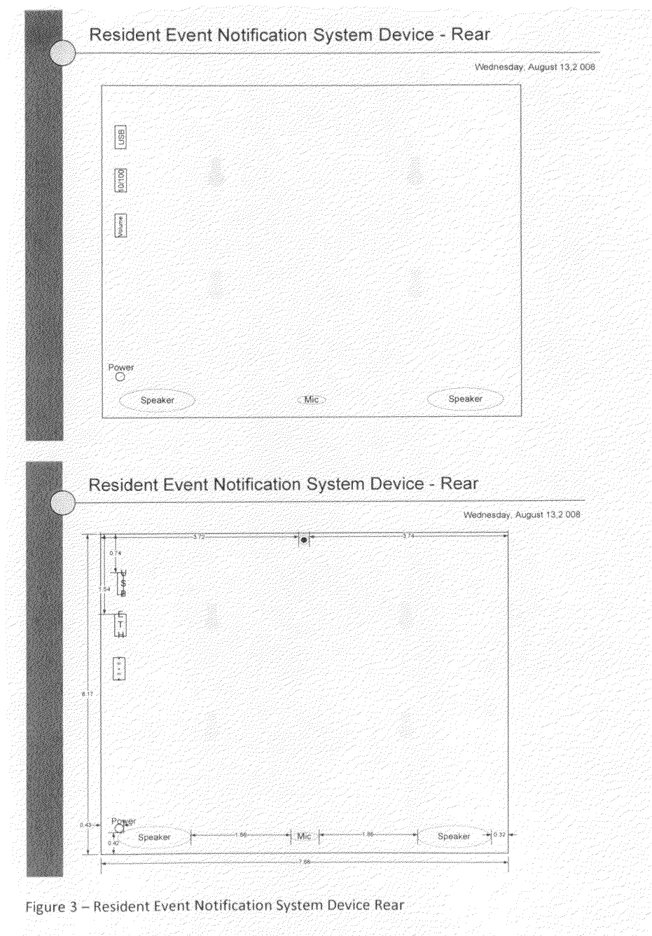

The rear of the device FIG. 3 would have mounting receptacles for vertical (wall) mount and a foldable stand for horizontal (desk, nightstand, counter) environments. A clip will be included on the back of the device to secure the power and phone cords. The device will include mounting mechanism to ensure the devices is not dropped or falls off the mounting platform when touched to acknowledge an event.

Access to a Lithium Ion (Li-Ion) battery will be available from the rear of the unit. The Lithium Ion battery will be used during power outages to display event reminders only. This will require a poll of the power status of the device and in times of power outages, the Lithium Ion battery will maintain power to the device to display the reminders. During times between events, the screen would be blank and all other functions hibernated to conserve power until line AC power has been restored.

### Device Side

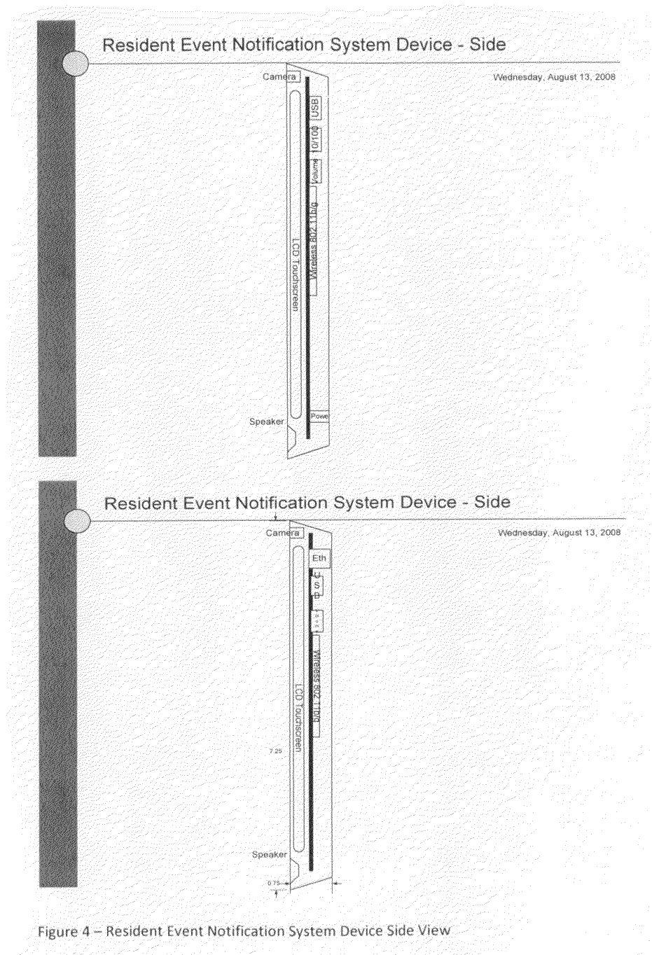

The side of the unit FIG. 4 will house a memory SIMM slot supporting SD, MicroSD, Compact Flash, Duo and Duo Pro, USB ports, Ethernet port, and other user interfaces. A feature should be included on the device setup web page to disable any unused port. Alternative designs should include a cellular capability for rural areas where HSI is not available. The speakers would require a volume control on the side of the device.

### Operating System and Application

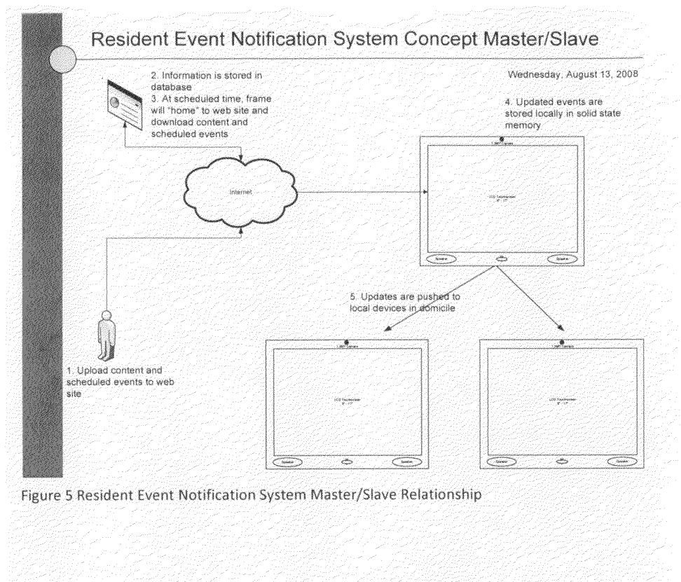

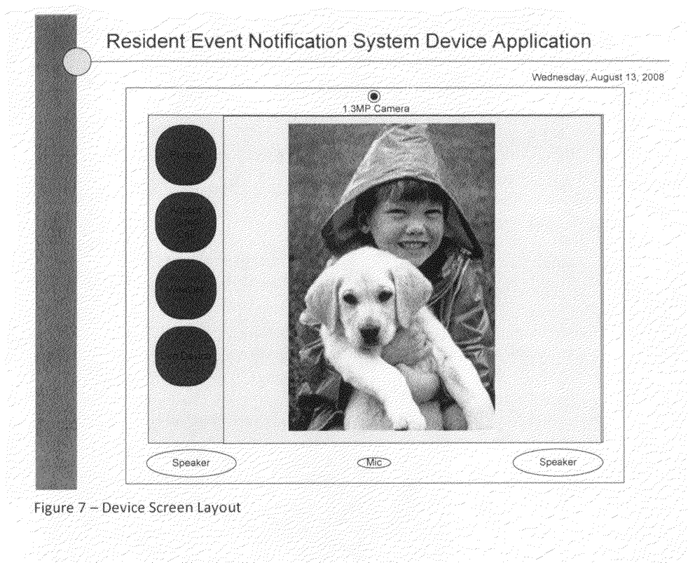

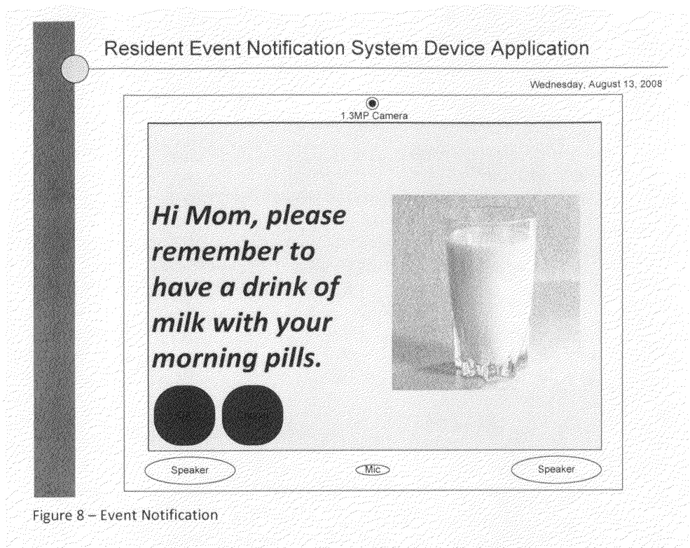

The operating system FIGS. 5, 6, 7, and 8 would support the “on-board” devices such as the Video Camera, USB, Ethernet Port, speakers and media slots. Embedded in the device would be a web browser which would connect to a secured internet site for updates. See Services section for additional details concerning the web portal.

To address multiple devices per household, a master/slave design would be needed. The hardware design is the same. However, the NOC update would occur between the Master HSI and then pushed from the Master to the WiFi connected Slave devices. In this scenario, a single device—the Master—would be connected to the internet. All other devices would pull event and photographs from the internet Master connected device. Benefits of this method of update would ensure synchronization between all devices and reduce overall connectivity requirements.

To ensure serviceability of the product, the frame should not function unless it has been registered with the site. This will ensure the appropriate services and features have been enabled.

An issue to be reviewed and/or researched would be rural areas within the United States. In areas where HSI (High Speed Internet) is not available, alternative technologies such as Cellular or Analog must be provided.

A potential issue associated with this type of replication is did the device(s) actually receive the updates. Since a feedback methodology may not be incorporated into this device in the initial phase, it is an assumed receipt of updates is successful each replication period. The purpose of this device is to provide reminder prompts to mild cognitive impaired residents, developmentally disabled, or seniors who live alone. Because a feedback loop may not developed in Phase I, a legal review should be performed to ensure appropriate verbiage is included in the instruction manual regarding the use of the product. A log of updates between the Master/Web Site could be maintained to record a device poll record—this is defined as the Master accessing the secured web site, inquiring if additional events or photos are available and downloading those items.

With any type of service, registration ensures appropriate information is displayed on the appropriate device. Therefore, a registration process of a device must be employed to ensure units who are not associated with each other do not receive information destined for the other. To achieve, this registration/activation process will need to be performed by the user. This seven step process associates the device with the customer.

The frame application will be used to display photographs and when scheduled, prompt the resident with the reminder event. The frame will be divided into two panels. The left panel is for soft keys which will be used by the resident to navigate the frame. Keys such as Photos, Weather or Dim Device may be enabled allowing the resident to perform these functions. In the above example, the keys would be used for the following purposes;
Photos—This would return the screen back to the photo show
Videos—This would play pre-recorded videos from family members
Accept Video Call—this would enable the resident to accept a video conference
Weather—This would allow the resident to view the current/5 day weather
Dim Device—This would dim the display for example to take a nap

When a scheduled event occurs the screen would change to remind the resident of the event. This could include both visual and audio prompts.

In this event notification, a reminder event for the resident was scheduled. At the predefined time, the event is displayed on the screen with an audio prompt—which could be a tone, beep or voice recording of the manager scheduling the event. For purposes of this document, the manager is the person accessing the web site and entering the event. The soft keys will allow the resident to acknowledge the event. In Phase I the event acknowledgement may or may not be recorded in the NOC. Additionally, the display could be a recorded video reminding the resident to perform the task or event.

### Services

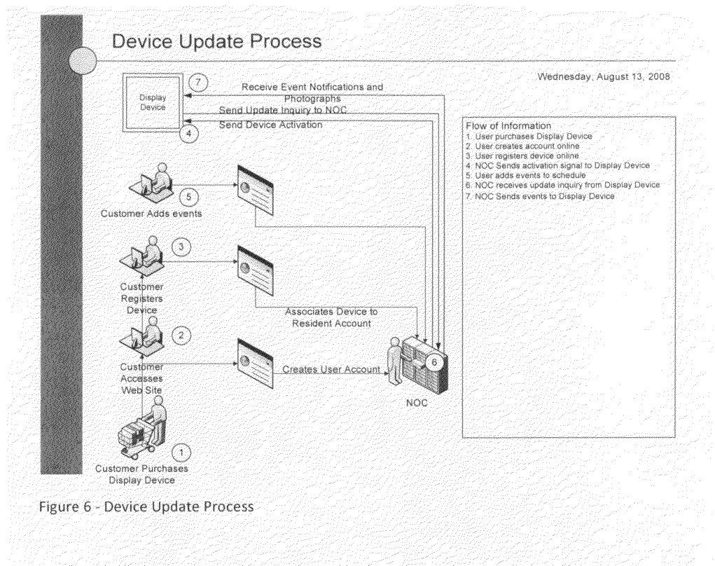

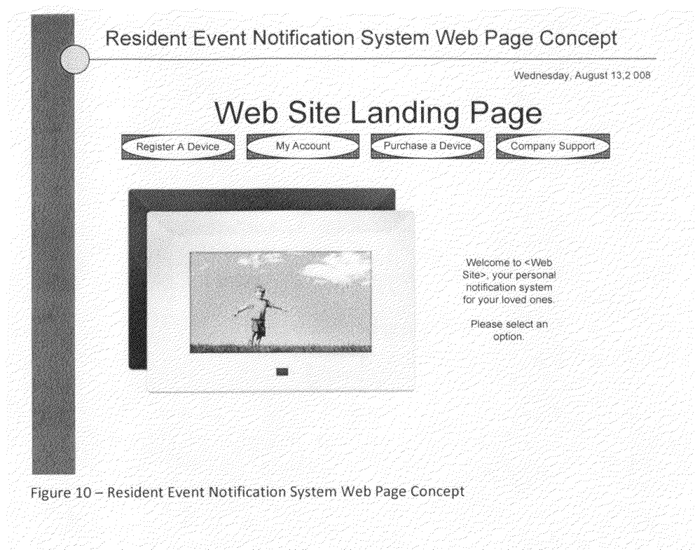

Some of the hardware for this project already exists within the market place, and is further being developed with a local manufacturer. However, the uniqueness of this concept/design is the service offered (FIGS. 6, 7, 8, 9, 10, and 11). While sites exist which allow you to share photographs, load events and receive e-mail reminders or provide e-mails to individuals without computers, the concept of loading personally recorded reminders or associated events and replicating those events to individuals in a distributed environment does not exist. Service companies are developing call trees which will contact loved ones at predefined times, however, persons with mild cognitive impairments may not respond to the call since they are unfamiliar with the person calling or the request being made.

Services associated with this product would be a combination of web pages and concierge activities. The Resident Event Notification System would be responsible for software warranty services. A web portal would be created where a Manager may register a device, enter events, up-load and manage photographs and record video reminders. The concierge services are representatives located within a call center, focused upon assisting customers who might not be able to update the information directly. Concierge services could be offered at a premium versus web updates.

There are many concerns regarding internet portals and the security of information contained within the portal. SSL encryption is a minimum level of security to access the page. Additional security measurements should be implemented to protect and associate the device to the customer to ensure unauthorized updates are not performed.

### Web Portal

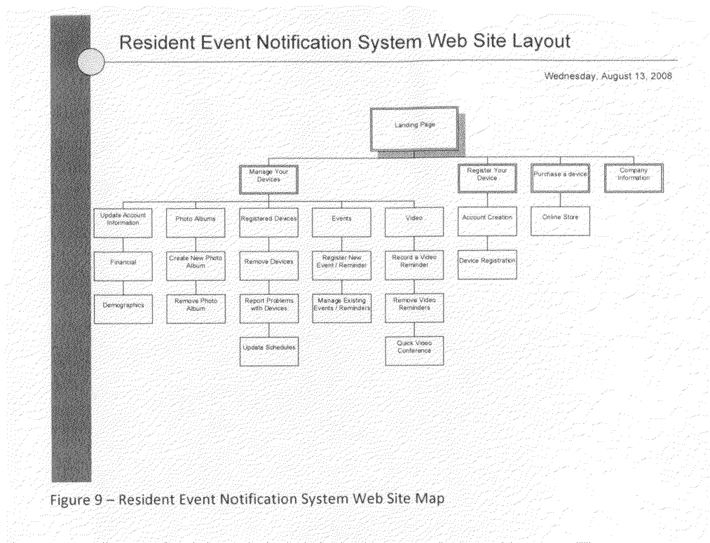

The web portal (FIG. 9) would consist of a customer landing page, registration page, authentication page, and a series of menus to perform management and maintenance tasks for the device. A site plan for the website is depicted below;

Security is of utmost concern to this product. Multiple security mechanisms must be built into the web portal to ensure the confidentiality and protection of The Display Device. SSL 128 bit encryption should be employed for any communications between the Display Device and web portal. User sessions should employ SSL 128 bit encryption. Additionally, each Display Device should be associated with customer accounts so that slave units will only replicate with the master unit associated with the customer account.

All transactions recorded within the database should be encrypted to ensure protection of the customer information. While HIPAA does not apply to this environment, similar protection methods should be employed. Recording of any transaction update should be written to a transaction log should any research be required. A legal review should be conducted regarding the storage of transaction log to ensure appropriate company protections are enabled.

Web pages for this site (FIG. 9) would include the following;
Landing Page
Manage Your Devices
Register Your Device
Purchase The Display Device
Company Information

The Landing Page is the main URL www.DisplayDevice.com (for example). Customers will access the web portal via this URL. This page is informational on the product and directs the customer to the services, devices or purchasing aspects of the device/service.

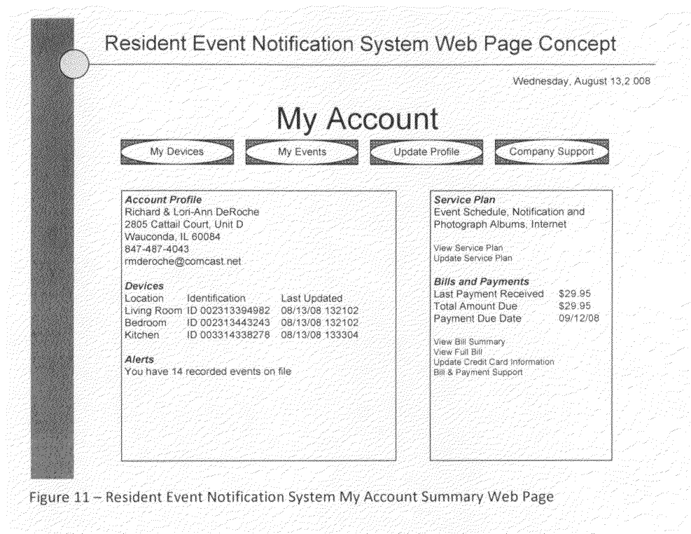

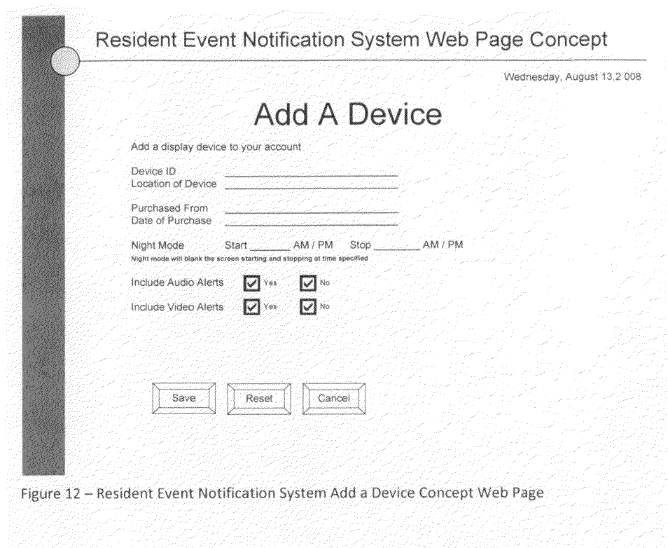

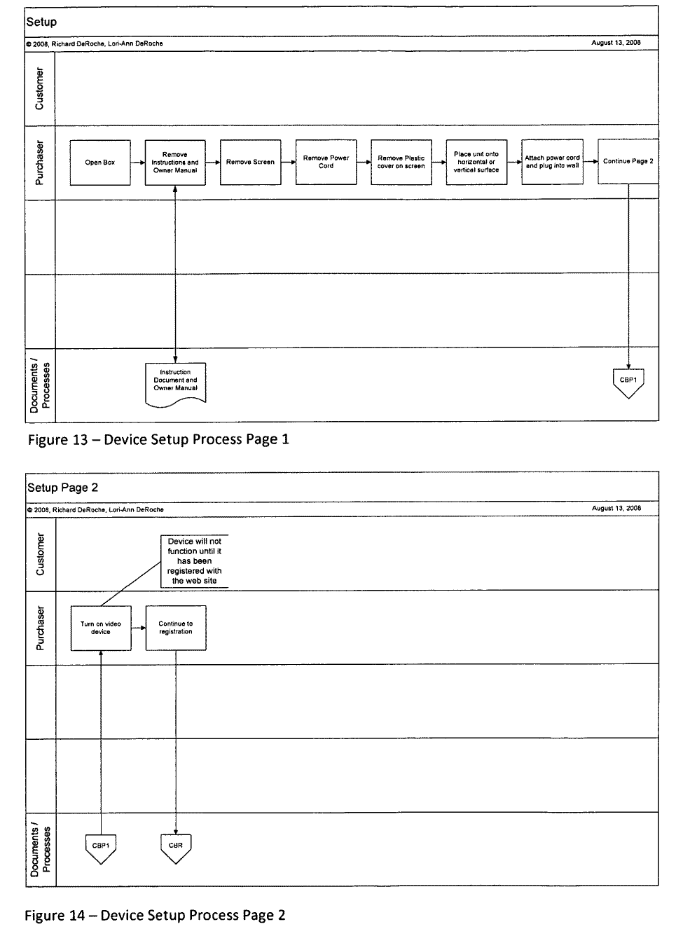

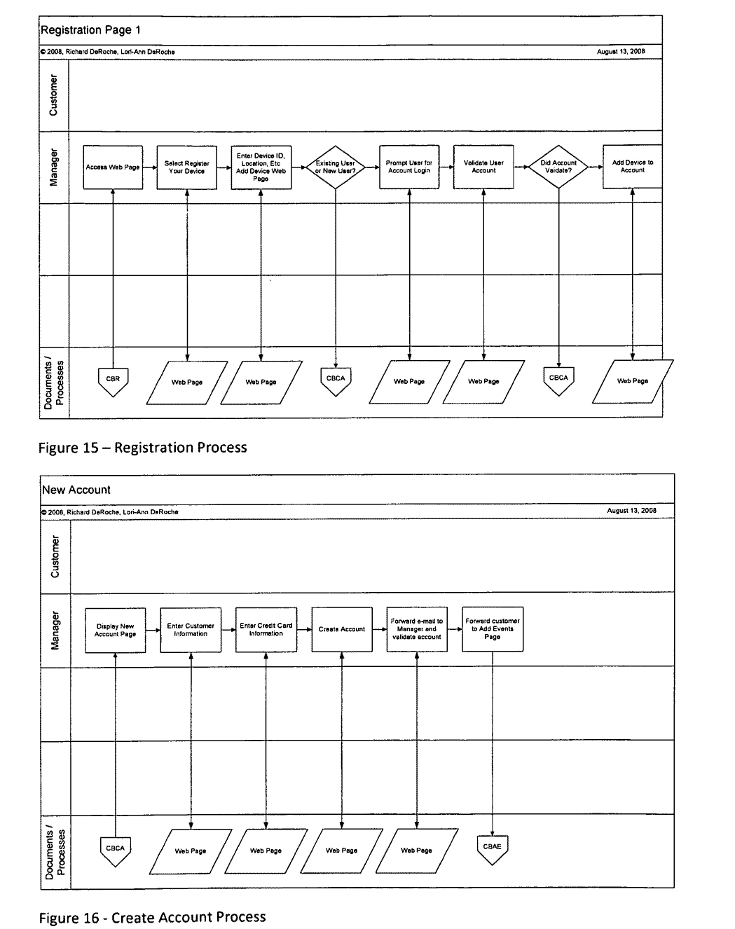

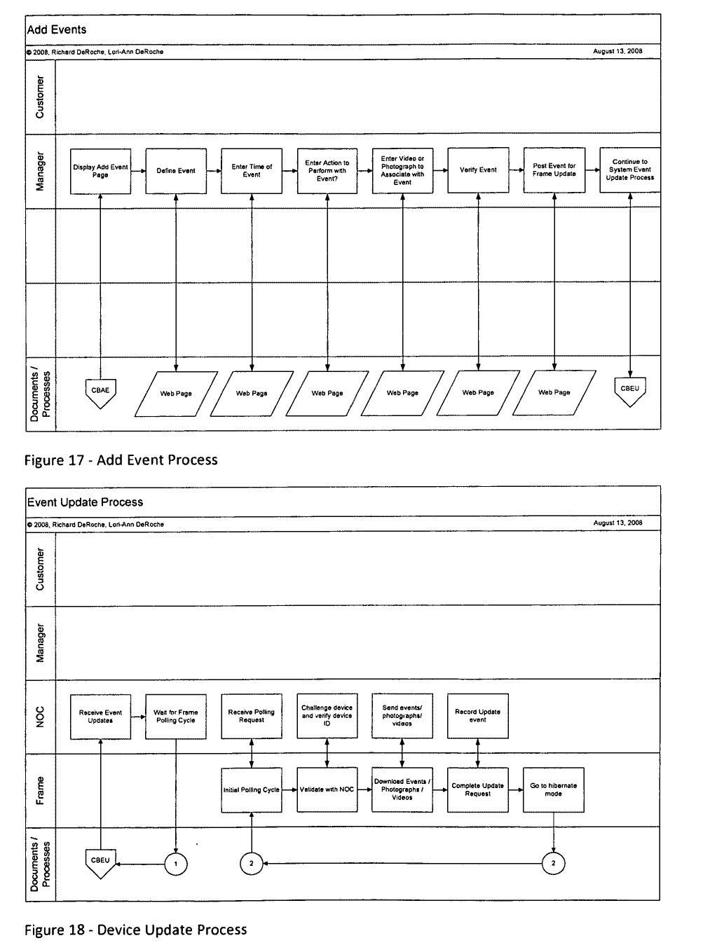

Manage Your Devices (FIGS. 11 and 12) is the customer login page for the web site. Under this tab, customers will have the ability to add new Display Devices, remove (or disable) Display Devices, record, edit and schedule events. Once the user has authenticated with the site, their device and event summaries are presented. Customers may then update/create new/remove events from the Display Device. The photo gallery section will allow the user to load or remove pictures from the Display Device. As well, customers may set a night mode for the Display Device. This night mode blanks the screen for the hours selected. Customer manuals may be downloaded from this page.

Register Your Device is for the customer to create a new account and register their first Display Device. If an existing customer purchases another device they will manage that device under Manage Your Device. Once the customer enters their information and creates their account. An email will be sent to the address entered. This is the authentication between the service/customer. From there, the customer will interact with the Manage Your Devices page. This page will also outline the service agreement for the Display Device.

Purchase The Display Device is the online store for purchasing a Display Device or registering for the service. Devices purchased through this outlet will be mailed directly to the customer location. As an alternative, online purchasing may direct the customer to a retail outlet for the device.

Company Information will display information concerning the service levels, locations and manufacturing information.

1. Our claim and focus of intellectual property is the development of an application residing on a digital display device and a web portable with database. The application on the device allows for the download/upload of information from the web portal. The web portal allows the consumer to upload information which may be photographs, videos or music. Additionally, the consumer may upload reminder events which will be displayed on the digital display at the defined time. This event may be acknowledged by the individual or will timeout within 10 minutes of display. Of importance is the acknowledgement of the event. If events go unacknowledged it may be indicative of potential issues with the user of the system. These issues may include Dementia, Alzheimer's, Developmentally Disabled, or any individual requiring a reminder system.
Our intellectual property is the development of the Digital Display Device application which synchronizes with a web portal to download photographs, music or videos.
The developers of this product and intelectual property owners are;

| | |
|---|---|
| Richard M DeRoche | Lori-Ann DeRoche |
| 415 June Terrace | 415 June Terrace |
| Barrington, Illinois 60010 | Barrington, Illinois 60010 |
| 847-987-8275 | 847-624-0556 |
| US Citizen | US Citizen |
